(19) United States
(12) Patent Application Publication
(10) Pub. No.: US 2017/0024174 A1
(43) Pub. Date: Jan. 26, 2017

(54) IMAGE FORMING APPARATUS AND IMAGE FORMING METHOD

(71) Applicants: KABUSHIKI KAISHA TOSHIBA, Tokyo (JP); TOSHIBA TEC KABUSHIKI KAISHA, Tokyo (JP)

(72) Inventor: Akihiro MORO, Sunto Shizuoka (JP)

(21) Appl. No.: 15/165,365

(22) Filed: May 26, 2016

(30) Foreign Application Priority Data
Jul. 23, 2015 (CN) 201510437067.6

(51) Int. Cl. G06F 3/12; H04N 1/00

(52) U.S. Cl. CPC G06F 3/1258; H04N 1/00411; G06F 3/1205; G06F 3/1219; H04N 2201/0094

(57) ABSTRACT

According to an embodiment, an image forming apparatus includes a storage section, a display section, an input section, an image forming section, and a control section. The storage section stores in advance image data and setting information indicating the conditions for forming an image based on the image data on a sheet. The display section displays the setting information. The input section receives user input relating to the selection of the setting information. The image forming section forms an image on the sheet using a decoloring toner. The control section controls the image forming section to execute the image formation according to conditions indicated by the setting information selected by the user.

### CROSS-REFERENCE TO RELATED APPLICATION

This application is based upon and claims the benefit of priority from Chinese Patent Application No. 201510437067.6, filed on Jul. 23, 2015; the entire contents of which are incorporated herein by reference.

### FIELD

Embodiments described herein relate generally to an image forming apparatus and an image forming method.

### BACKGROUND

There exists a decoloring toner with a characteristic of fading at a certain fixed temperature that effectively erases and/or covers images formed by the decoloring toner previously printed on a medium. In light of an increase in social recognition of environmental protection in recent years, image forming apparatuses capable of printing using a decoloring toner have come into practical use. Decoloring devices which decolor images that are printed using a decoloring toner have also come into practical use. A user may reuse paper onto which a decoloring toner is printed by using such an image forming apparatus and a decoloring device.

However, in an image forming apparatus of the related art, other apparatuses or storage media are necessary in order to print a decoloring image. For example, in the related art, it is necessary for a user to transmit image data to the image forming apparatus using a personal computer (PC) on which a print driver is installed. For example, it is necessary for the user to cause the image forming apparatus to load the image data by connecting a storage medium on which the image data is stored to the image forming apparatus. In this manner, in the related art, it may be difficult to print a decoloring image by operating only the image forming apparatus.

Such reuse of paper is considered to be in high demand in relation to printed objects which have standard content. Performing print operations such as those described above every time printing of such standard content is performed is labor intensive. Therefore, enabling printing of a decoloring image by operating only the image forming apparatus is desirable.

### BRIEF DESCRIPTION OF THE DRAWINGS

FIG. 1 is an external appearance view illustrating an example of an image forming apparatus according to an embodiment.

FIG. 2 is a block diagram illustrating the hardware configuration of the image forming apparatus.

FIG. 3 is a block diagram illustrating the functional configuration of the image forming apparatus.

FIG. 4 is a diagram illustrating a specific example of an image information table.

FIG. 5 is a diagram illustrating a specific example of a paper settings table.

FIG. 6 is a diagram illustrating a specific example of a density settings table.

FIG. 7 is a block diagram illustrating the details of a system control section.

FIG. 8 is a diagram illustrating a specific example of ECO print image data.

FIG. 9 is a diagram illustrating a specific example of the ECO print image data.

FIG. 10 is a diagram illustrating a specific example of the ECO print image data.

FIG. 11 is a diagram illustrating a specific example of a menu screen for ECO printing.

FIG. 12 is a diagram illustrating a specific example of a paper settings screen.

FIG. 13 is a diagram illustrating a specific example of a density settings screen.

FIG. 14 is a diagram illustrating a specific example of a menu screen when a selection enlarge button is pressed.

FIG. 15 is a flowchart illustrating the process flow of ECO printing by the image forming apparatus according to the embodiment.

FIG. 16 is a flowchart illustrating the process flow of ECO printing by the image forming apparatus according to the embodiment.

FIG. 17 is a flowchart illustrating the process flow of a print settings process.

FIG. 18 is a diagram illustrating an example of paper in which, in an image which is printed using mixed printing, only the image formed by ECO printing is decolored.

### DETAILED DESCRIPTION

In general, according to an embodiment, an image forming apparatus includes a storage section, a display section, an input section, an image forming section, and a control section. The storage section stores in advance image data and setting information indicating the conditions for forming an image based on the image data on a sheet. The display section displays the setting information. The input section receives user input relating to the selection of the setting information. The image forming section forms an image on the sheet using a decoloring toner. The control section controls the image forming section to execute the image formation according to conditions indicated by the setting information selected by the user.

Hereinafter, description will be given of the image forming apparatus and the image forming method according to the embodiment with reference to the drawings.

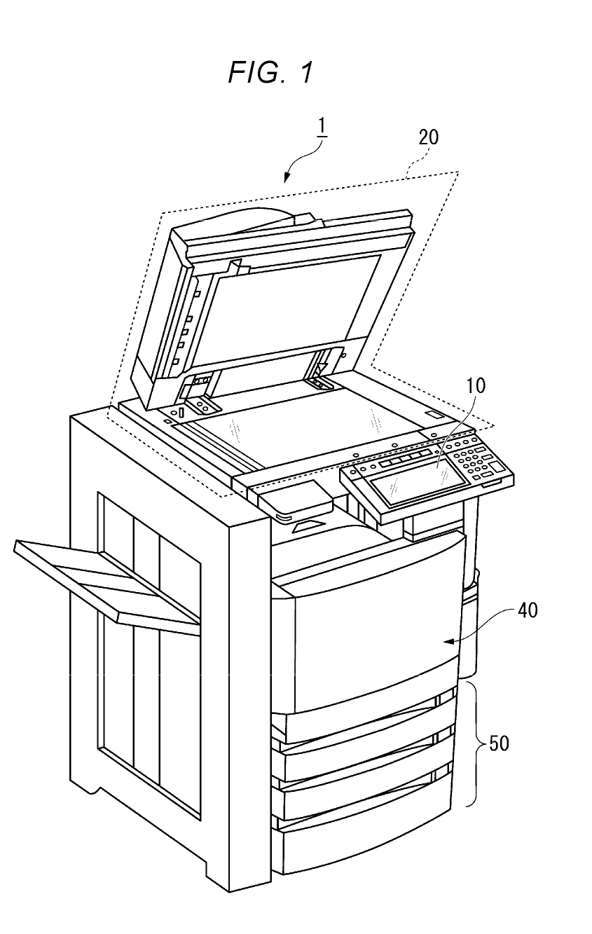

FIG. 1 is an external appearance view illustrating an example of an image forming apparatus 1 according to the embodiment.

The image forming apparatus 1 is a multifunction peripheral (MFP), for example. The image forming apparatus 1 acquires print target image data, and forms the image indicated by the image data on a printing sheet. The image data may be generated by reading a sheet with the print target image, and may be generated in advance. The image data which is generated in advance may be data which is stored in the apparatus, and may be acquired from another apparatus or storage medium. The image forming apparatus 1 prints the acquired image data using a decoloring toner or a non-decoloring toner.

Hereinafter, printing in which a decoloring toner is used will be referred to as “ECO printing”, and printing in which a non-decoloring toner is used will be referred to as “ordinary printing”. Although the printing sheet is not limited to paper, to facilitate explanation, hereinafter, the printing sheet will be denoted as printing paper.

The sheet read by the image forming apparatus 1 is paper or the like on which a document, characters, images or the like are depicted, and the sheet may be any object as long as the object can be read by the apparatus 1. The image forming apparatus 1 is not limited to an image forming apparatus which uses a toner image fixing system, and an ink jet system image forming apparatus may also be used. In the depicted example, the image forming apparatus 1 includes an operation section 10, a scanner section 20, a print section 40, and a paper feed section 50.

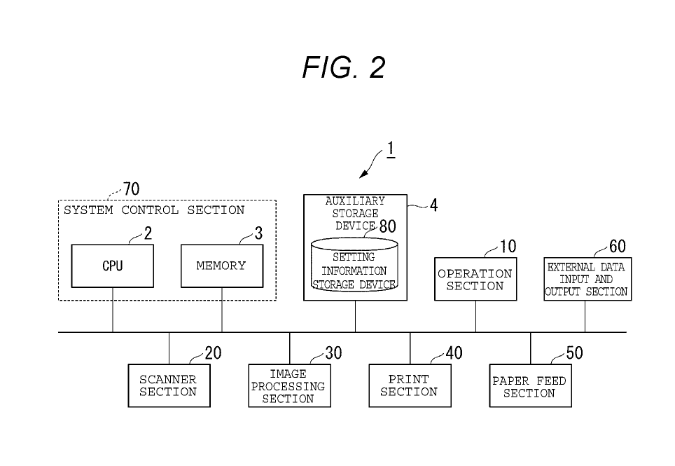

FIG. 2 is a block diagram illustrating the hardware configuration of the image forming apparatus 1.

The image forming apparatus 1 includes a central processing unit 2 (CPU), a memory 3, an auxiliary storage device 4, and the like which are connected to a bus, and the image forming apparatus 1 executes an image processing program. For example, an image forming program is stored, in advance, on the auxiliary storage device 4 and is read onto the memory 3 by the CPU 2. Due to the CPU 2 executing the image forming program, the image forming apparatus 1 functions as an apparatus which includes the operation section 10, the scanner section 20, an image processing section 30, the print section 40, the paper feed section 50, and an external data input and output section 60. In other words, in the image forming apparatus 1, the CPU 2 and the memory 3 function as a system control section 70 which controls each functional section. The auxiliary storage device 4 includes a storage device such as a magnetic hard disk or a semiconductor storage device. The auxiliary storage device 4 functions as a storage section which stores, in addition to the image processing program described above, various information relating to the printing process such as image data. For example, the auxiliary storage device 4 functions as a setting information storage section 80 which stores the setting information indicating the conditions relating to the printing process.

Note that all or a portion of the functions of the image forming apparatus 1 may be realized using hardware such as an application specific integrated circuit (ASIC), a programmable logic device (PLD), or a field programmable gate array (FPGA). The image forming program may be recorded on a computer-readable recording medium. The computer-readable recording medium is a storage device such as a transportable medium such as a flexible disc, a magneto-optic disk, a ROM, a CD ROM, or alternatively, a hard disk embedded in a computer system. The image forming program may be transmitted via an electrical communication line.

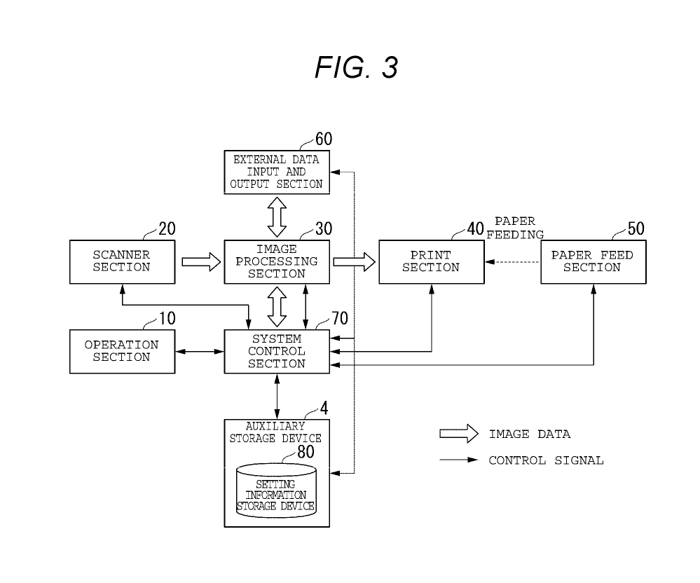

FIG. 3 is a block diagram illustrating the functional configuration of the image forming apparatus 1.

The operation section 10 receives input of a user operation in relation to the image forming apparatus 1. Specifically, the operation section 10 comprises a display section and an input section. For example, the display section includes a display device such as a liquid crystal display or an organic electroluminescence (EL) display. The input section includes an input device such as a keyboard or a touch panel. The operation section 10 generates input information indicating the content of operations which are input from the input section and outputs the input information to the system control section 70. The input information includes information relating to the printing process performed by the image forming apparatus 1. For example, the input information includes information indicating whether to perform color printing or monochrome printing, information indicating whether to perform ECO printing or ordinary printing, information indicating whether to perform duplex printing or simplex printing, and the like.

The scanner section 20 reads an image on a sheet using an image sensor such as a CCD or a CIS, and generates the image data. The CCD is an acronym of charge coupled device. The CIS is an acronym of contact image sensor. The scanner section 20 outputs the generated image data to the image processing section 30.

The image processing section 30 subjects the image data which is generated by the scanner section 20, or the image data, which is acquired from an external device or a storage medium, to image processing. For example, the image processing section 30 realizes compositing, enlarging, shrinking, image quality improvement and the like of the image using image processing. The image processing section 30 outputs the image data which is subjected to the image processing to the print section 40.

The print section 40 prints the image data which is output from the image processing section 30 to onto the printing paper. If the input information indicates ECO printing, the print section 40 prints the image indicated by the image data using a decoloring toner. Meanwhile, if the input information indicates ordinary printing, the print section 40 prints the image indicated by the image data using a non-decoloring toner.

The paper feed section 50 supplies the printing paper to the print section 40.

The external data input and output section 60 (an image data acquisition section) inputs and outputs image data between the external data input and output section 60 and an external device or a storage medium. For example, the external data input and output section 60 may include a communication interface of a local area network (LAN) or the like. The external data input and output section 60 acquires the image data from the external device via the network. The external data input and output section 60 may provide image data which is generated within the apparatus to the external device. For example, the external data input and output section 60 may include an input and output device which inputs information to, and outputs information from, a recording medium such as a CD-ROM or a floppy disc. In this case, the external data input and output section 60 may acquire the image data by accessing the recording medium described above. The external data input and output section 60 may provide the image data to an external device by recording the image data onto the recording medium.

The system control section 70 controls the functional sections of the image forming apparatus 1. The ECO printing process, using the ECO print image data, is realized by the operation of the functional sections of the image forming apparatus 1 under the control of the system control section 70. The system control section 70 will be described later in detail.

The setting information storage section 80 stores, in advance, the image data (hereinafter referred to as the “ECO print image data”) which is used in the ECO printing process. The setting information storage section 80 stores the setting information for each item of ECO print image data in advance. For example, the setting information indicates settings such as the parameters used in the image processing, the fixing temperature of the toner, and the transport speed of the paper. In the ECO printing process, depending on the printing density, un-decolored portions (i.e., portions of previously printed characters or images on the paper that is being decolored) may remain when the image decoloring is performed. Paper with different characteristics depending on the use or object, for example, paper from which the toner is easily decolored, or paper which is suitable for repeated use is used as the printing paper used in the ECO printing process. Therefore, in the ECO printing process, setting the density according to the characteristics of the paper is important. Therefore, in the present embodiment, a case is supposed in which the setting information includes settings relating to the density, and settings relating to the type of paper, which are important in the ECO printing process.

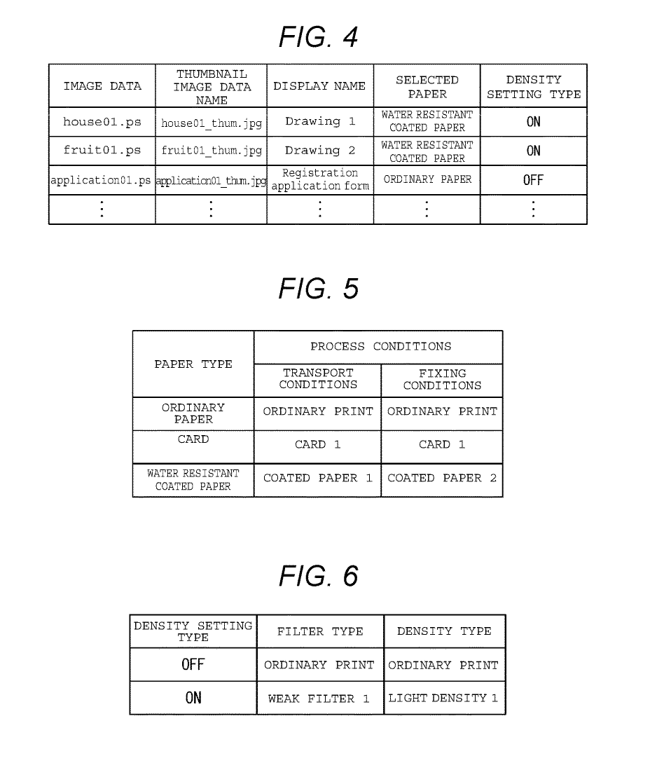

As settings relating to the density, settings relating to the filter processing and the density adjustment process are important for the suppression of un-decolored portions which remain when the image decoloring is performed. Un-decolored portions which remain when the image decoloring is performed generally occur the most in character portions and photograph portions. Therefore, in the ECO printing process, filter processing, which weakens or reduces the sharpness (i.e., resolution) of the character portions, and density adjustment processing, which reduces the density of the photograph portions, are necessary. For this reason, in the present embodiment, settings relating to the filter processing and the density adjustment processing described above are supposed as settings relating to the density. Note that, the setting information may include any other settings as long as the settings are necessary in the ECO printing process. Hereinafter, the settings relating to the density will be referred to as the density settings, and the settings relating to the printing paper will be referred to as the paper settings. For example, the setting information storage section 80 stores the setting information in an image information table, a paper settings table, and a density settings table which are illustrated in the following FIGS. 4 to 6.

FIG. 4 is a diagram illustrating a specific example of the image information table.

The image information table stores the correlation between the ECO print image data, and the paper settings and the density settings. The image information table includes an image information record for each image data name item. The image information record includes values of the image data name, a thumbnail image data name, a display name, and the types of selected paper and density settings. A file name indicating the ECO print image data is held in the image data name item. A file name indicating the thumbnail image data of the ECO print image data is held in the thumbnail image data name item. Information indicating the properties of the ECO print image data is held in the display name item. The display name may be information indicating any property of the ECO print image data. In the present embodiment, the display name is assumed to be information indicating the use of the ECO print image data. For example, the display name is associated with the thumbnail image and displayed on the settings screen on which the user confirms or registers the setting information. Information indicating the type of the printing paper which is associated with the ECO print image data is held in the selected paper item. Information indicating the type of density settings corresponding to the ECO print image data is held in the density setting type item. In the example in FIG. 4, one of the values of ON or OFF is provided in the density setting type item. The image information records are stored in advance in the image information table based on the specified values of each item. The values of the items contained in the image information records may be changed by a user, as necessary.

FIG. 5 is a diagram illustrating a specific example of the paper settings table.

The paper settings table includes information indicating the paper settings relating to the ECO printing process. The paper settings table includes a paper settings record for each paper type item. The paper settings records include values of the paper type and process conditions. Information indicating the type of the printing paper is contained in the paper type item. Information indicating the execution conditions of the printing process according to the process conditions is contained in the process conditions item. In the present embodiment, a description is given of a case in which the process conditions have two execution conditions: the fixing conditions and the transport conditions. The fixing conditions are data indicating the conditions relating to the fixing of the toner such as the fixing temperature of the toner. The transport conditions are data indicating the conditions relating to the transporting of the printing paper, such as the transport speed of the printing paper. The example in FIG. 5 indicates that the fixing conditions and the transport conditions of the ordinary paper are set to “ordinary print”. The correspondence relationship between the values which are contained in the process conditions items and the specific parameter values is stored in advance in the auxiliary storage device 4 (FIG. 2). The paper settings records are registered in advance in the paper settings table based on the specified values of each item. The values of the items held by the paper settings records may be changed by a user, as necessary.

FIG. 6 is a diagram illustrating a specific example of the density settings table.

The density settings table contains information indicating the density settings relating to the ECO printing. The density settings table includes a density settings record for each density setting type item, indicating the type of the density settings. The density setting type is information which is registered in density setting type of the image information record of FIG. 4. If the density setting type is represented by a value of either “ON” or “OFF” as in the example of FIG. 4, the density settings table contains two density settings records. The density settings record includes values of the density setting type, the filter type, and the density type. The filter type indicates the type of the setting which is used in the filter processing of the ECO print image data. The density type indicates the type of the density settings in the printing of the ECO print image data. In the example in FIG. 6, if the density setting type is “ON”, this indicates that the filter processing is performed using the “ordinary print” setting, and the printing is performed using the “ordinary print” setting density.

The correspondence relationship between the values which are contained in the filter type and density type items and the specific parameter values is stored in advance in the auxiliary storage device 4 (FIG. 2). The density settings records are registered in advance in the density settings table based on the specified values of each item. The values of the items held by the density settings records may be changed by a user, as necessary.

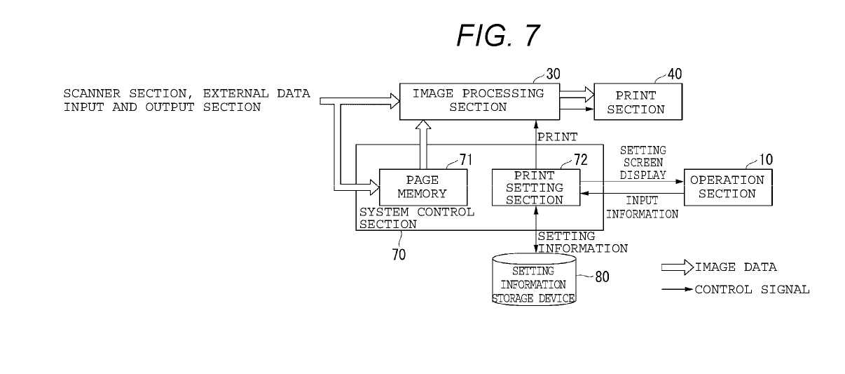

FIG. 7 is a block diagram illustrating the details of the system control section 70.

First, description will be given of the system control section 70. The system control section 70 includes a page memory 71 and a print setting section 72.

The page memory 71 is a storage medium which temporarily stores the image data which is output from the scanner section 20 (FIG. 2). For example, the page memory 71 includes the memory 3. For example, the image data which is necessary for the page sorting and collation, changing of the print order, and the like, is temporarily stored in the page memory 71. The page memory 71 outputs the image data, which is subjected to these processes, to the image processing section 30. Note that if the processes are not necessary, the image data is directly output to the image processing section 30.

The print setting section 72 performs the processes relating to the settings of the ECO printing and controls the execution of the ECO printing. Specifically, the print setting section 72 causes the operation section 10 to display a menu screen relating to the ECO printing and controls the changing of settings and the execution of the ECO printing according to the user input. The print setting section 72 generates the print settings for causing the functional sections to execute the ECO printing process based on the setting information and the input information. When the print setting section 72 receives input of an ECO printing execution command, the print setting section 72 outputs the generated print settings to the functional sections and causes the functional sections to execute the ECO printing process.

Next, description will be given of the image processing section 30. The image processing section 30 subjects the image data to image processing such as a color conversion process, a filter process, a region recognition process, a density adjustment process, a scaling process, and a gradation process. The image processing section 30 performs the filter process and the density adjustment process based on the density settings which are included in the print settings which are output from the print setting section 72.

The print section 40 prints the image indicated by the image data onto the printing paper. The print section 40 prints the image using a non-decoloring toner in the ordinary printing process, and prints the image using a decoloring toner in the ECO printing process.

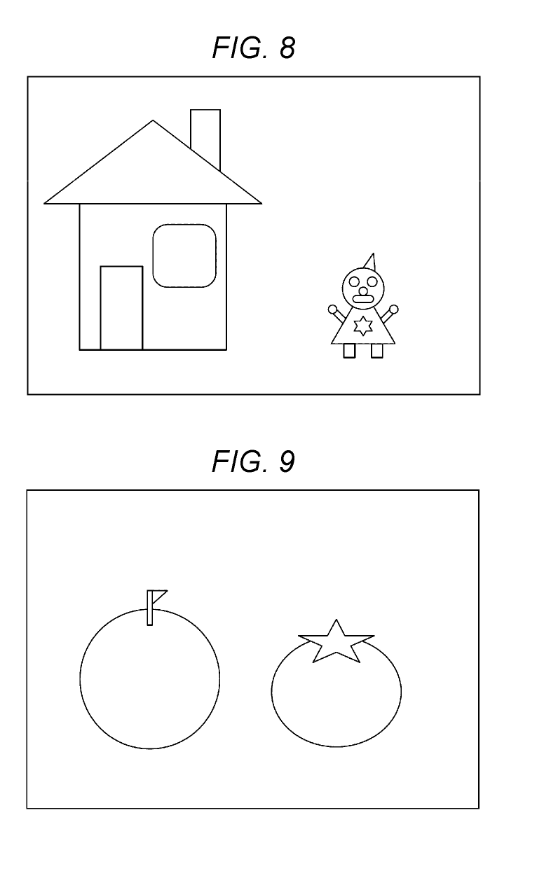

FIGS. 8 to 10 are images illustrating specific examples of the ECO print image data.

FIGS. 8 and 9 are images of outlines used in color-in pictures for children. For example, a kindergarten teacher or the like prints such an outline image onto water resistant coated paper using the ECO printing process. The teacher allows children to color in the outline which is printed onto the water resistant coated paper using water-based pens. Once the coloring-in is finished, the teacher may use the water resistant coated paper again by washing the water resistant coated paper with water and inserting the coated paper with the outline images into a decoloring device.

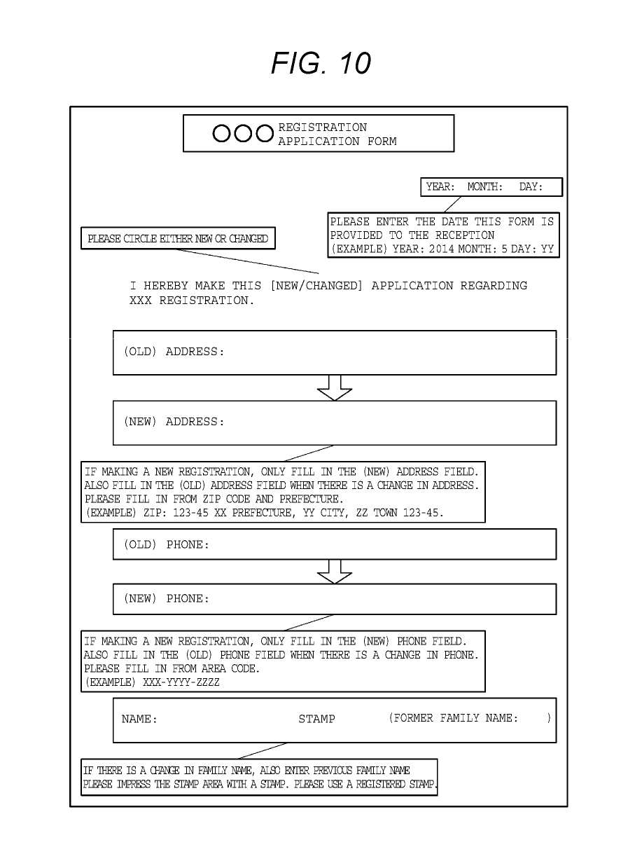

FIG. 10 is an image of a document describing a guide to completing an application to an applicant. If such standard documents are printed using the ECO printing, the printing paper may be reused by collecting used documents and inserting the used documents into a decoloring device.

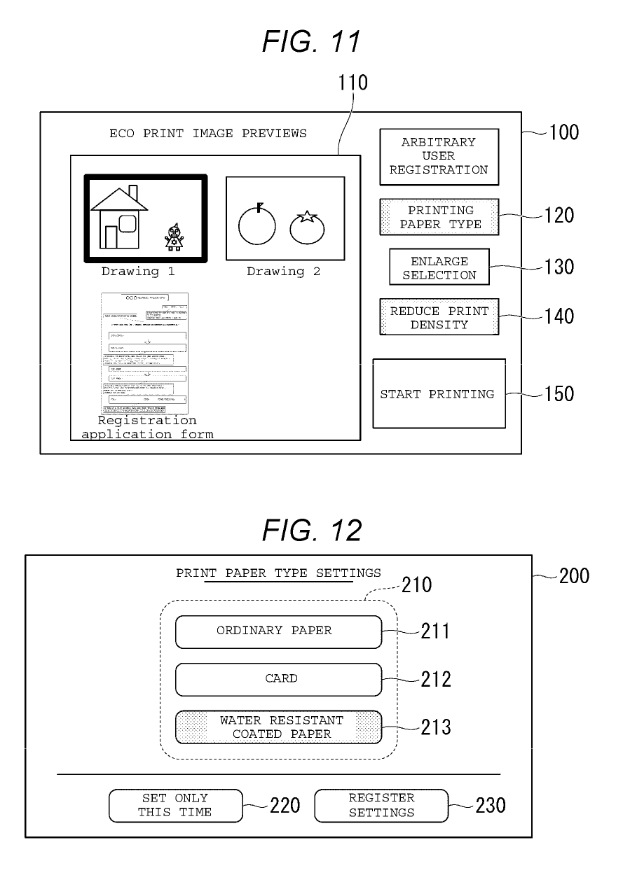

FIG. 11 is a diagram illustrating a specific example of a menu screen for the ECO printing.

For example, a setting screen 100 in FIG. 11 includes a preview region 110, a printing paper selection button 120, a selection enlarge button 130, a print density reduction button 140, and a print execution button 150. The preview region 110 displays a list of ECO print image data which is registered in the image forming apparatus 1. The preview region 110 displays thumbnails of the ECO print image data together with the display names. The user specifies the target image data to perform the ECO printing process by selecting the displayed thumbnail image.

The printing paper selection button 120 is a button on the paper settings screen for allowing the user to set the paper settings to be displayed. The selection enlarge button 130 is a button for causing the thumbnail image which is selected by the user to be displayed in a larger size. The print density reduction button 140 is a button for causing the density settings screen for allowing the user to set the density settings to be displayed. The print execution button 150 is a button for allowing the user to input the execution of the ECO printing using the set print settings.

The printing paper selection button 120 and the print density reduction button 140 indicate whether or not the print settings are changed from the specified values by the display mode of the buttons. Using such a display, the image forming apparatus 1 may prompt the user to check the print settings.

In the example in FIG. 11, the thumbnail image of “drawing 1” is selected as the target for which to perform the ECO printing process. For the print settings of the ECO print image data of “drawing 1” which is selected, it may be confirmed that both the paper settings and the density settings are modified from the specified values. In this case, for example, the user presses the printing paper selection button 120 and the print density reduction button 140, as necessary, and causes the setting screen to be displayed. After the user checks or changes the print settings from the setting screen, the user presses the print execution button 150 and causes the ECO printing to be executed.

FIG. 12 is a diagram illustrating a specific example of the paper settings screen.

For example, a paper settings screen 200 includes a paper selection region 210, a temporary setting button 220, and a setting registration button 230. The paper selection region 210 is a region in which selection buttons for allowing the user to select the paper are arranged. In the example in FIG. 12, selection buttons 211 to 213 are arranged in the paper selection region 210. The selection button 211 is a button for selecting ordinary paper. The selection button 212 is a button for selecting thick paper or card stock. The selection button 213 is a button for selecting water resistant coated paper. The selection buttons 211 to 213 indicate the paper type that is set through the display mode of the buttons. When the paper settings screen is displayed, the paper type which is set currently is displayed. The display mode of the selection buttons may be changed according to the user selection. The example in FIG. 12 indicates that the water resistant coated paper is selected (indicated by shading within button 213).

The temporary setting button 220 and the setting registration button 230 are buttons for ending the paper settings. The temporary setting button 220 is an end button which is used when the changed paper settings are used temporarily. When the temporary setting button 220 is pressed, the changed paper settings are not registered in the setting information storage section 80. The setting registration button 230 is an end button which is used when the changed paper settings are registered in the setting information storage section 80 (FIG. 3). When the setting registration button 230 is pressed, the changed paper settings are registered in the setting information storage section 80 and are used during subsequent printing processes unless changed by the user.

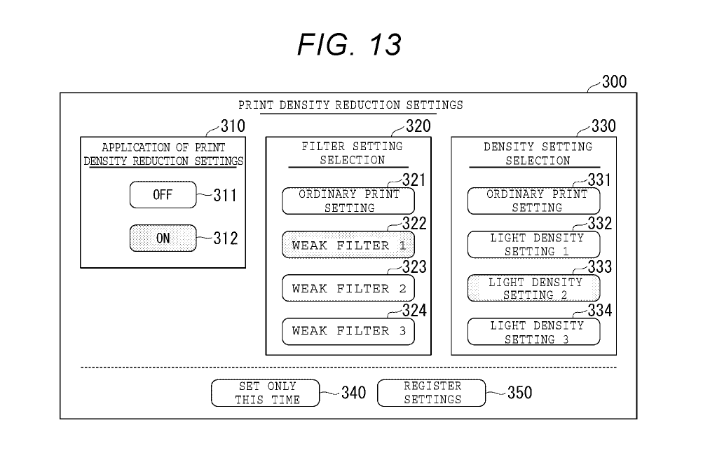

FIG. 13 is a diagram illustrating a specific example of the density settings screen.

For example, the density settings screen 300 includes a density setting type selection region 310, a filter selection region 320, a density selection region 330, a temporary setting button 340, and a setting registration button 350.

The density setting type selection region 310 is a region in which selection buttons for selecting the type of the density settings to be applied in the ECO printing process. In the example in FIG. 13, selection buttons 311 and 312 are arranged in the density setting type selection region 310. The selection button 311 is a button for selecting the density setting type that is defined by the value “OFF” in the density settings table in FIG. 6. The selection button 312 is a button for selecting the density setting type that is defined by the value “ON” in the density settings table in FIG. 6. The selection buttons 311 and 312 indicate the density setting type that is set through the display mode of the buttons. When the density settings screen is displayed, the density setting type which is set currently is displayed. The display mode of the selection buttons may be changed according to the user selection. The example in FIG. 13 indicates that the density setting type which is defined by “ON” is selected (indicated by shading within button 312).

The filter selection region 320 is a region in which selection buttons for selecting the filter type are arranged. In the example in FIG. 13, selection buttons 321 to 324 are arranged in the filter selection region 320. The selection button 321 is a button for selecting the filter type that is defined by the value “ordinary print setting” in the density settings table in FIG. 6. The selection button 322 is a button for selecting the filter type that is defined by the value “weak filter 1” setting in the density settings table in FIG. 6. The selection button 323 is a button for selecting the filter type that is defined by the value “weak filter 2” setting in the density settings table in FIG. 6. The selection button 324 is a button for selecting the filter type that is defined by the value “weak filter 3” setting in the density settings table in FIG. 6. The selection buttons 321 to 324 indicate the filter type that is set through the display mode of the buttons. When the density settings screen is displayed, the current filter type that is associated with the density setting type is displayed. The display mode of the selection buttons may be changed according to the user selection. The example in FIG. 13 indicates that the filter type that is defined by “weak filter 1” setting is selected (indicated by shading within button 322).

The density selection region 330 is a region in which selection buttons for selecting the density type are arranged. In the example in FIG. 13, selection buttons 331 to 334 are arranged in the density selection region 330. The selection button 331 is a button for selecting the density type that is defined by the value “ordinary print setting” in the density settings table in FIG. 6. The selection button 332 is a button for selecting the density type that is defined by the value “light density setting 1” in the density settings table in FIG. 6. The selection button 333 is a button for selecting the density type that is defined by the value “light density setting 2” in the density settings table in FIG. 6. The selection button 334 is a button for selecting the filter type that is defined by the value “light density setting 3” in the density settings table in FIG. 6. The selection buttons 331 to 334 indicate the density type that is set through the display mode of the buttons. When the density settings screen is displayed, the current density type that is associated with the density setting type is displayed. The display mode of the selection buttons may be changed according to the user selection. The example in FIG. 13 indicates that the density type that is defined by “light density setting 2” is selected (indicated by shading within button 333).

The temporary setting button 340 and the setting registration button 350 are buttons for ending the density settings. The temporary setting button 340 is an end button which is used when the changed density settings are used temporarily. When the temporary setting button 340 is pressed, the changed density settings are not registered in the setting information storage section 80 (FIG. 7). The setting registration button 350 is an end button which is used when the changed density settings are registered in the setting information storage section 80. When the setting registration button 350 is pressed, the changed density settings are registered in the setting information storage section 80 and are used during subsequent printing processes unless changed by the user.

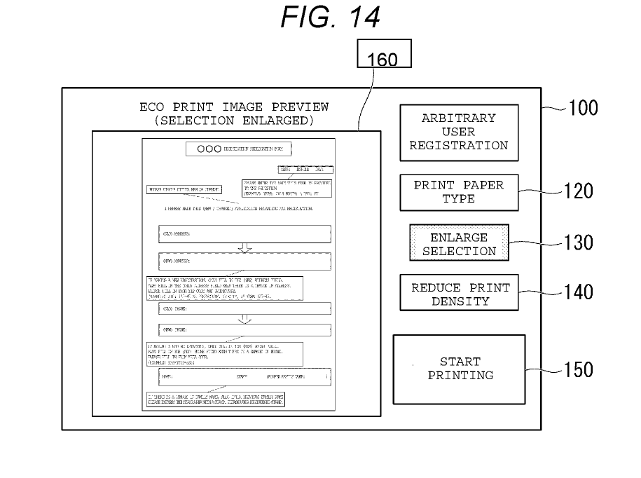

FIG. 14 is a diagram illustrating a specific example of a menu screen when the selection enlarge button 130 is pressed.

In the menu screen of the ECO printing, when the selection enlarge button 130 is pressed, the display of the preview region 110 of FIG. 11 switches to an enlarged display region 160. An enlarged image of the selected thumbnail image is displayed in the enlarged display region 160.

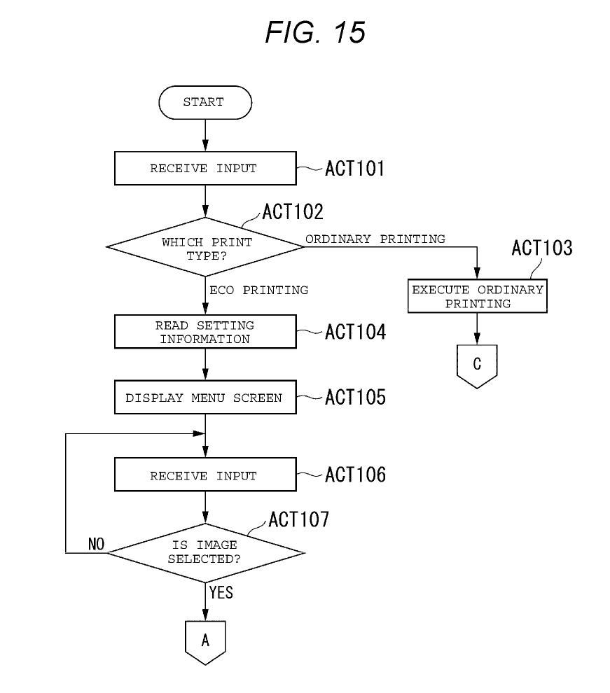

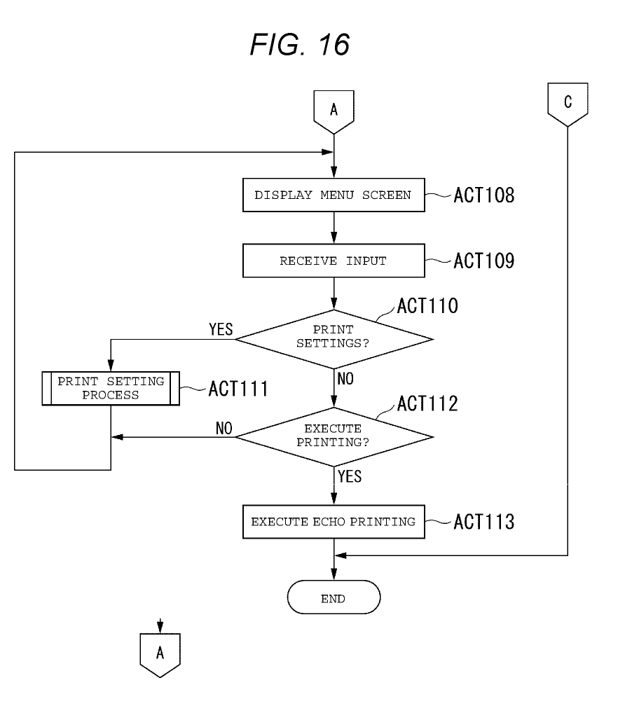

FIGS. 15 and 16 are flowcharts illustrating the process flow of the ECO printing process by the image forming apparatus 1 of FIG. 1 according to the embodiment.

At the starting time of the flowchart depicted in FIG. 15, the image forming apparatus 1 causes the operation section 10 to display a selection screen of the print type. The operation section 10 receives input of the selection of the print type (ACT101). The operation section 10 outputs the input information to the print setting section 72 (FIG. 7). The print setting section 72 determines the print type which is selected based on the input information (ACT102) If the selected print type is ordinary printing (ACT102: ordinary printing), the print setting section 72 acquires the settings relating to ordinary printing from the setting information storage section 80 (FIG. 3). The print setting section 72 outputs the acquired settings to the image processing section 30 and the print section 40 (both shown in FIG. 3). Accordingly, the image forming apparatus 1 executes the ordinary printing (ACT103).

Meanwhile, if the selected print type is ECO printing (ACT102: ECO printing), the print setting section 72 acquires the setting information of the ECO printing from the setting information storage section 80 (ACT104). The print setting section 72 causes the operation section 10 to display the menu screen of the ECO printing based on the acquired setting information (ACT105). At this time, the print setting section 72 refers to the image information table and acquires the thumbnail image names of the ECO print image data which is registered. The print setting section 72 acquires the thumbnail image data indicated by the acquired thumbnail image names from the setting information storage section 80. The print setting section 72 associates the acquired thumbnail image data with the display names and displays a list of the associated items on the menu screen.

The operation section 10 receives user input to the menu screen (ACT106). The operation section 10 generates input information indicating the input content based on the user input. The operation section 10 outputs the generated input information to the print setting section 72. The print setting section 72 determines whether or not the ECO print image data which is the print target is selected based on the input information (ACT107). Specifically, the print setting section 72 determines whether or not the selection of the thumbnail image is input. When the print setting section 72 determines that the ECO print image data is not selected (ACT107—NO), the print setting section 72 returns to ACT106. The print setting section 72 repeatedly executes ACT106 and ACT107 until the selection of the ECO print image data is input. Meanwhile, when the print setting section 72 determines that the ECO print image data is selected (ACT107—YES), the print setting section 72 causes the operation section 10 to display the menu screen again (ACT108). Here, the print setting section 72 acquires the setting information of the selected ECO print image data from the setting information storage section 80. The print setting section 72 temporarily stores the settings indicated by the acquired setting information as the print settings to be used in the current ECO printing. Hereinafter, the print settings which are temporarily stored will be referred to as the temporary settings. The print setting section 72 causes the menu screen to be displayed depending on the display mode corresponding to the temporary settings.

Next, the operation section 10 receives the user input to the menu screen (ACT109). The operation section 10 generates input information indicating the input content based on the user input. The operation section 10 outputs the generated input information to the print setting section 72. The print setting section 72 determines whether or not a change command of the print setting section is input based on the input information (ACT110). If the print setting section 72 determines that the update command of the print settings is input (ACT110—YES), the print setting section 72 causes the operation section 10 to display the setting screen and executes the print settings process (ACT111). After executing the print settings process, the print setting section 72 returns to ACT108 and causes the operation section 10 to display the menu screen again.

Meanwhile, if the print setting section 72 determines that the update command of the print settings is not input (ACT110—NO), the print setting section 72 determines whether or not the execution command of the ECO printing is input based on the input information (ACT112). If the print setting section 72 determines that the execution command of the printing process is not input (ACT112—NO), the print setting section 72 returns to ACT108 and causes the operation section 10 to display the menu screen again. Meanwhile, if the print setting section 72 determines that the execution command of the printing process is input (ACT112—YES), the print setting section 72 outputs the selected ECO print image data and print settings to the image processing section 30 and the print section 40. The image processing section 30 and the print section 40 execute the ECO printing using the print settings which are acquired from the print setting section 72 (ACT113).

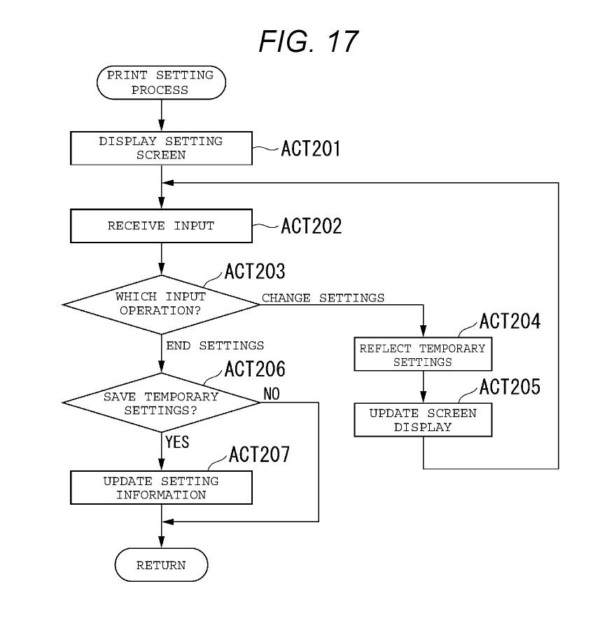

FIG. 17 is a flowchart illustrating the process flow of the print settings process.

First, the print setting section 72 determines the type of the print settings based on the input information which is acquired in ACT109 in FIG. 16. The print setting section 72 causes the operation section 10 to display the setting screen corresponding to the type of the print settings (ACT201). At this time, if the type of the print settings indicated by the input information is the paper settings, the print setting section 72 causes the operation section 10 to display the paper settings screen. For example, when the printing paper selection button 120 in FIG. 11 is pressed, the paper settings screen in FIG. 12 is displayed. At this time, if the type of the print settings indicated by the input information is the density settings, the print setting section 72 causes the operation section 10 to display the density settings screen. For example, when the print density reduction button 140 in FIG. 11 is pressed, the density settings screen in FIG. 13 is displayed. The print setting section 72 causes various setting screens to be displayed depending on the display mode corresponding to the temporary settings at the time.

The operation section 10 receives user input to the setting screen (ACT202). The operation section 10 generates input information indicating the input content based on the user input. The operation section 10 outputs the generated input information to the print setting section 72.

The print setting section 72 determines the type of operation which is input based on the input information (ACT203). If the input operation is a settings changing operation (ACT203: change settings), the print setting section 72 reflects the updated content in the temporary settings (ACT204). A case in which the input operation is a settings changing operation is a case in which, for example, one of the selection buttons 211 to 213 in FIG. 12 is pressed. In this case, the print setting section 72 updates the setting screen to a display mode corresponding to the temporary settings (ACT 205). After the display of the setting screen is updated, the print setting section 72 returns to ACT202 and the operation section 10 receives the user input.

Meanwhile, if the input operation is a settings ending operation (ACT203: end settings), the print setting section 72 determines whether or not saving the temporary settings is necessary (ACT206). A case in which the input operation is a settings ending operation is a case in which, for example, one of the temporary setting button 340 or the setting registration button 350 in FIG. 13 is pressed. The print setting section determines whether saving the temporary settings is necessary by determining which of the buttons is pressed based on the input information.

If saving the temporary settings is necessary (ACT206 —YES), the print setting section 72 updates the setting information which is stored in the setting information storage section 80 with the content of the temporary settings (ACT207). A case in which the saving of the temporary settings is necessary is a case in which, for example, the setting registration button 350 in FIG. 13 is pressed. Meanwhile, if the saving of the temporary settings is not necessary (ACT206—NO), the print setting section 72 ends the print settings process without updating the setting information. A case in which the saving of the temporary settings is not necessary is a case in which, for example, the temporary setting button 340 in FIG. 13 is pressed.

The image forming apparatus 1 according to the embodiment which is configured in this manner stores the ECO print image data in advance. The image forming apparatus 1 includes a function of allowing the target image data of the ECO printing to be selected from the ECO print image data that is stored in advance. Based on this function, a user can perform the printing of the ECO print image data by operating only the image forming apparatus 1.

The image forming apparatus 1 stores the setting information indicating the print settings relating to the ECO printing for each item of ECO print image data. Therefore, a user may perform the ECO printing process using the print settings corresponding to the selected ECO print image data.

Hereinafter, description will be given of a modification example of the image forming apparatus 1 according to another embodiment.

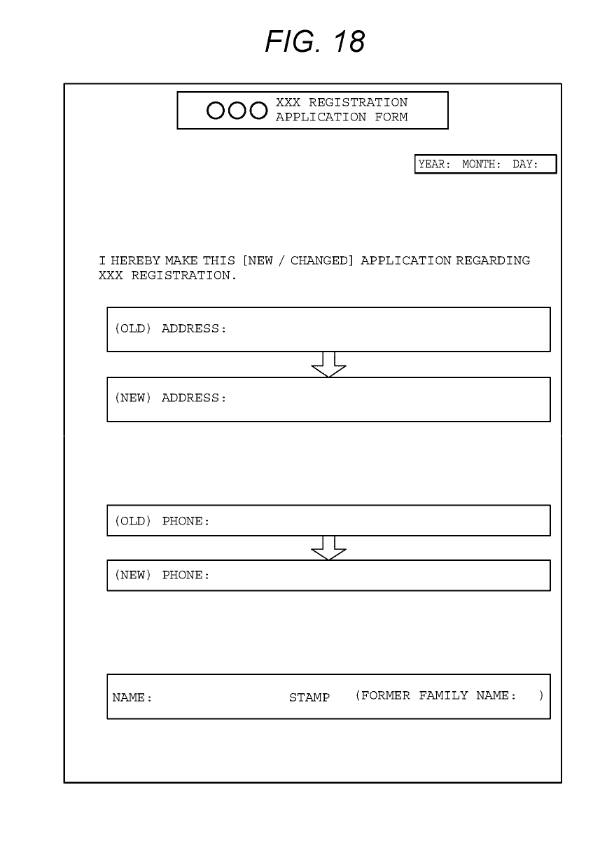

The image forming apparatus 1 may perform ordinary printing for a portion of the image which is printed using ECO printing. Such printing will be provisionally referred to as mixed printing. For example, in this case, the image forming apparatus 1 prints only the entry instructions in FIG. 10 using the ECO printing process, and prints the other portions using the ordinary printing process. If paper which is printed on using such mixed printing is inserted into a decoloring device, the paper in which only the entry instructions are decolored may be obtained, as in FIG. 18. If paper forms printed in this manner are distributed, paper which is used only for the explanation of the entry instructions becomes unnecessary. By configuring the image forming apparatus 1 in this manner, paper consumption can be suppressed. Note that the image forming apparatus 1 may realize the mixed printing by performing the ECO printing process and the ordinary printing process at the same time, and may realize the mixed printing by performing the ECO printing process and the ordinary printing process separately. Here, “at the same time” means executing the fixing processes in the ECO printing process and the ordinary printing process using one fixing process. When performing the mixed printing, region information for identifying the region in which to perform the ECO printing and the region in which to perform the ordinary printing becomes necessary in the printing target image data. The image forming apparatus 1 may combine the image data for ECO printing with the image data for ordinary printing and generate the image data for mixed printing including the region information. The image forming apparatus 1 may extract features of the image using image processing and generate the region information based on the extracted image features.

The image forming apparatus 1 may include a registration section which performs additional registration of the ECO print image data according to the user input. In this case, the image forming apparatus 1 acquires the image data to be additionally registered from an external device or storage medium via the external data input and output section 60 (FIG. 3). The registration section may decolor or modify the ECO print image data which is registered in advance.

According to at least one of the embodiments described above, by providing an image forming apparatus with a storage section that stores image data which is supposed to be deleted after printing, and setting information indicating settings relating to the printing of each item of image data in advance, a printing section that prints an image indicated by the image data using a decoloring toner, an input and output section that displays information relating to the image data and receives input of information relating to the printing of the image data from a user, and a control section that controls the printing of the image data by the printing section based on the setting information and the information input by the user, the image data supposed to be deleted after the printing can be printed by operating only the image forming apparatus.

In this embodiment, ‘decoloring’ means to make it difficult to recognize a color of an image formed on an image receiving member after the image is formed on the image receiving member by an recording material which has different color from the color of the image receiving material. The color of recording material may be achromatic color including black or white, not limiting to chromatic color. And in the embodiments, ‘decoloring the image’ means ‘erasing the image’.

While certain embodiments have been described, these embodiments have been presented byway of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a storage section that stores, in advance, image data and setting information indicating conditions for forming an image on a sheet based on the image data;
a display section that displays the setting information;
an input section that receives user input relating to selection of the setting information;
an image forming section that forms an image on the sheet using a decoloring toner; and
a control section that controls the image forming section to execute the image formation according to conditions indicated by the setting information selected by the user.

2. The apparatus according to claim 1,
wherein the setting information includes settings relating to a filter process that reduces a sharpness of the image or a density adjustment process that reduces a density of a photograph portion in order to suppress un-decolored portions which exist when decoloring the image, and
wherein the control section controls the image forming section to execute the filter process or the density adjustment process based on the setting information selected by the user.

3. The apparatus according to claim 2,
wherein the setting information is set for each type of the sheet,
wherein the input section receives input selecting a type of the sheet, and
wherein the control section controls the image forming section to execute the image formation based on the setting information corresponding to the type of the sheet selected by the user.

4. The apparatus according to claim 3,
wherein the setting information is set for each item of the image data,
wherein the input section receives input selecting the image data, and
wherein the control section controls the image forming section to execute the image formation based on the setting information corresponding to the image data selected by the user.

5. The apparatus according to claim 4,
wherein the control section causes the display section to display a list of the image data stored in the storage section,
wherein the input section receives input selecting the image data from the list, and
wherein the control section causes the image forming section to execute the image formation based on the setting information corresponding to the image data selected from the list.

6. The apparatus according to claim 5,
wherein the input section receives input relating to changes in the setting information by the user, and
wherein the control section temporarily changes the setting information acquired from the storage section according to the user input and causes the image forming section to execute the image formation based on the setting information which is temporarily changed.

7. The apparatus according to claim 6,
wherein the control section updates the setting information which is stored in the storage section in advance with the setting information that is temporarily changed according to the user input.

8. The apparatus according to claim 1, further comprising:
a registration section that decolors, changes, or registers the image data based on the user input.

9. The apparatus according to claim 8, further comprising:
an image data acquisition section that acquires the image data from an external device or a storage medium,
wherein the registration section registers the image data acquired by the image data acquisition section.

10. An image forming apparatus, comprising:
a storage section that contains preloaded image data and setting information indicating conditions for forming an image on a sheet based on the image data;
a display section that displays the setting information;
an input section that receives user input relating to selection of the setting information;
an image forming section that forms an image on the sheet using a decoloring toner; and
a control section that controls the image forming section to execute the image formation according to conditions indicated by the setting information selected by the user, wherein the setting information includes settings relating to a filter process that reduces a resolution of the image or a density adjustment process that reduces a density of a photograph portion in order to suppress un-decolored portions which exist when decoloring the image.

11. The apparatus according to claim 10,
wherein the control section controls the image forming section to execute the filter process or the density adjustment process based on the setting information selected by the user.

12. The apparatus according to claim 11,
wherein the setting information is set for each type of the sheet,
wherein the input section receives input selecting a type of the sheet, and
wherein the control section controls the image forming section to execute the image formation based on the setting information corresponding to the type of the sheet selected by the user.

13. The apparatus according to claim 12,
wherein the setting information is set for each item of the image data,
wherein the input section receives input selecting the image data, and
wherein the control section controls the image forming section to execute the image formation based on the setting information corresponding to the image data selected by the user.

14. The apparatus according to claim 13,
wherein the control section causes the display section to display a list of the image data stored in the storage section,
wherein the input section receives input selecting the image data from the list, and
wherein the control section causes the image forming section to execute the image formation based on the setting information corresponding to the image data selected from the list.

15. The apparatus according to claim 14,
wherein the input section receives input relating to changes in the setting information by the user, and
wherein the control section temporarily changes the setting information acquired from the storage section according to the user input and causes the image forming section to execute the image formation based on the setting information which is temporarily changed.

16. The apparatus according to claim 15,
wherein the control section updates the setting information which is stored in the storage section in advance with the setting information that is temporarily changed according to the user input.

17. The apparatus according to claim 10, further comprising:
a registration section that decolors, changes, or registers the image data based on the user input.

18. The apparatus according to claim 17, further comprising:
an image data acquisition section that acquires the image data from an external device or a storage medium,
wherein the registration section registers the image data acquired by the image data acquisition section.

19. An image forming method carried out by an image forming apparatus which includes a storage section which stores image data and setting information indicating conditions for forming an image on a sheet based on the image data in advance, the method comprising:
displaying the setting information;
receiving user input relating to selection of the setting information;
forming an image on the sheet using a decoloring toner; and
controlling the forming to execute the image formation according to the conditions indicated by the setting information selected by the user.

20. The image forming method of claim 19,
wherein a portion of the image on the sheet is formed using a non-decolorable toner.
